(19) United States
(12) Patent Application Publication
(10) Pub. No.: US 2006/0225053 A1
(43) Pub. Date: Oct. 5, 2006

(54) Programming language improvements

(75) Inventors: Pratap Lakshman, Hyderabad (IN); Jayteerth N. Katti, Redmond, WA (US); Sadagopan Rajaram, Secunderabad (IN); Gopi Krishna Madabhushi, Redmond, WA (US); Jeffrey M. Cooperstein, Bellevue, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/256,634

(22) Filed: Oct. 21, 2005

Related U.S. Application Data
(60) Provisional application No. 60/621,532, filed on Oct. 21, 2004.

(51) Int. Cl. G06F 9/45

(52) U.S. Cl. 717/140; 717/106

(57) ABSTRACT

Multiple software facilities are described. A property mapping facility enables a programming language compiler to map properties defined according to one property accessor style to another property accessor style. A reference mapping facility enables a programming language compiler to emit instructions that cause a parameter to a method to be provided by reference even when the programming language does not support providing parameters by reference. A type extension facility enables a programming language compiler to extend the number of declarative type modifiers that the compiler supports. A partial class facility enables a programming language compiler to postpone compiling a class marked as partial until the compiler can compile the entire class. A value type facility enables a programming language compiler to recognize “value data types” that offer advantages of both reference data types and primitive data types.

### CROSS-REFERENCE TO RELATED APPLICATIONS

This patent application claims the benefit of U.S. Provisional Patent Application No. 60/621,532, entitled “Programming Language Improvements,” which was filed on Oct. 21, 2004, the disclosure of which is incorporated herein in its entirety by reference.

### BACKGROUND

Microsoft NET (“.NET”) is a software architecture having components that connect information, people, systems, and devices. It includes a .NET Framework, developer tools, server software, and client software. The .NET Framework is used for building and running software, including web-based applications, smart client applications, and XML web services. XML web services are components that facilitate integration of software components by sharing data and functionality over a network through standard, platform-independent protocols such as Extensible Markup Language (XML), Simple Object Access Protocol (SOAP), and Hypertext Transfer Protocol (HTTP). Developer tools, such as Microsoft Visual Studio®, provide an integrated development environment (IDE).

The .NET Framework is a Windows component used for building and running software applications and web services. It supports over twenty programming languages and makes it easy for software developers (“developers”) to build, deploy, and administer secure, robust, and high-performing applications. The NET Framework includes a common language runtime (CLR) and a unified set of class libraries.

The CLR provides run-time services, such as language integration, security enforcement, and memory, process, and thread management. During application development, CLR provides life-cycle management, strong type naming, cross-language exception handling, and dynamic binding to reduce the amount of code that a developer needs to write to turn business logic into an application program or a reusable component. Developers can employ various programming languages to generate an intermediate language (IL) that is executable by the CLR.

The set of class libraries in the .NET Framework includes base classes, ADO.NET classes, XML classes, ASP.NET classes, Windows Forms classes, and other classes. Base classes provide standard functionality such as input/output, string manipulation, security management, network communications, thread management, text management, and user interface design features. ADO.NET classes enable developers to interact with data through OLE DB, ODBC, SQL Server interfaces, and other data interfaces. XML classes enable XML manipulation, searching, and translations. The ASP.NET classes support the development of web-based applications and web services. The Windows Forms classes support the development of desktop-based smart client applications. Together, the class libraries provide a common, consistent development interface across all languages supported by the NET Framework, including Visual J# and Visual J++.

Visual J#.NET is a development language and set of tools for Java-language developers who desire to build applications and services for .NET. Visual J#.NET provides an easy transition for Java-language developers into XML web services and .NET. It also improves interoperability of Java-language programs with existing software written in a variety of other programming languages. Visual J#.NET includes technology that enables developers to migrate their Java-language programs to the .NET Framework. Existing applications developed with Microsoft Visual J++®, which is another development language and set of tools, can be easily migrated to execute in .NET, interoperate with other Microsoft .NET-connected applications and languages, and incorporate .NET functionality such as ASP.NET, ADO.NET, and Microsoft Windows® Forms. Further, developers can use Visual J#.NET to create entirely new .NET-connected applications. FIG. 2 is a block diagram illustrating a relationship between various .NET components.

Visual J#.NET is designed to receive as input Java source code and output IL code that is highly compatible with other .NET languages and tools. It uses programming syntax and semantics that are similar to the Java programming language. However, aspects of NET's CLR are different from the Java virtual machine (VM) that executes software programs and applets written in the Java programming language.

### SUMMARY

Multiple software facilities are described. A property mapping facility enables a programming language compiler to map properties defined according to one property accessor style to another property accessor style. A reference mapping facility enables a programming language compiler to emit instructions that cause a parameter to a method to be provided by reference even when the programming language does not support providing parameters by reference. A type extension facility enables a programming language compiler to extend the number of declarative type modifiers that the compiler supports. A partial class facility enables a programming language compiler to postpone compiling a class marked as partial until the compiler can compile the entire class. A value type facility enables a programming language compiler to recognize “value data types” that offer advantages of both reference data types and primitive data types. An event bridge facility bridges semantically different event technologies. A custom security facility enforces custom security semantics on components. A version-aware compilation facility provides errors during compilation when incorrect versions of types are used.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram illustrating an example of a suitable computing environment in which aspects of the facility may be implemented.

FIG. 2 is a block diagram illustrating a relationship between various NET components.

FIG. 3 is a flow diagram illustrating a compile_method_definitions routine employed by a property mapping facility in various embodiments.

FIG. 4 is a flow diagram illustrating a compile routine performed by a property mapping facility in various embodiments.

FIG. 5 is a flow diagram illustrating a compile routine invoked by a property mapping facility in an alternate embodiment.

FIG. 6 is a flow diagram illustrating a compile routine invoked by a reference mapping facility in various embodiments.

FIG. 7 is a flow diagram illustrating a compile routine invoked by a type extension facility in various embodiments.

FIG. 8 is a flow diagram illustrating a compile routine invoked by a partial class facility in various embodiments.

FIG. 9 is a flow diagram illustrating a compile routine invoked by the partial class facility in alternate embodiments.

FIG. 10 is a flow diagram illustrating a compile routine invoked by a value type facility in various embodiments.

FIG. 11 is a control flow diagram illustrating a flow of logical control between various components of an event bridge facility in various embodiments.

FIG. 12 is a flow diagram illustrating a bridge_events routine invoked by an event bridge facility in various embodiments.

FIG. 13 is a flow diagram illustrating a generate_listener routine performed by the event bridge facility in various embodiments.

FIG. 14 is a block diagram illustrating how trust flows through a custom security facility in various embodiments.

FIG. 15 is a flow diagram illustrating an apply_trust routine invoked by the custom security facility in various embodiments.

FIG. 16 is a flow diagram illustrating a transform_trust_level routine performed by the custom security facility in some embodiments.

FIG. 17 is a block diagram indicating inheritance of types.

FIG. 18 is a flow diagram illustrating a compile routine invoked by a version-aware compilation facility in various embodiments.

### DETAILED DESCRIPTION

Various facilities relating to programming language improvements are described. While they are described in relation to the Java programming language, some may also apply to other programming languages.

### ILLUSTRATED EMBODIMENTS

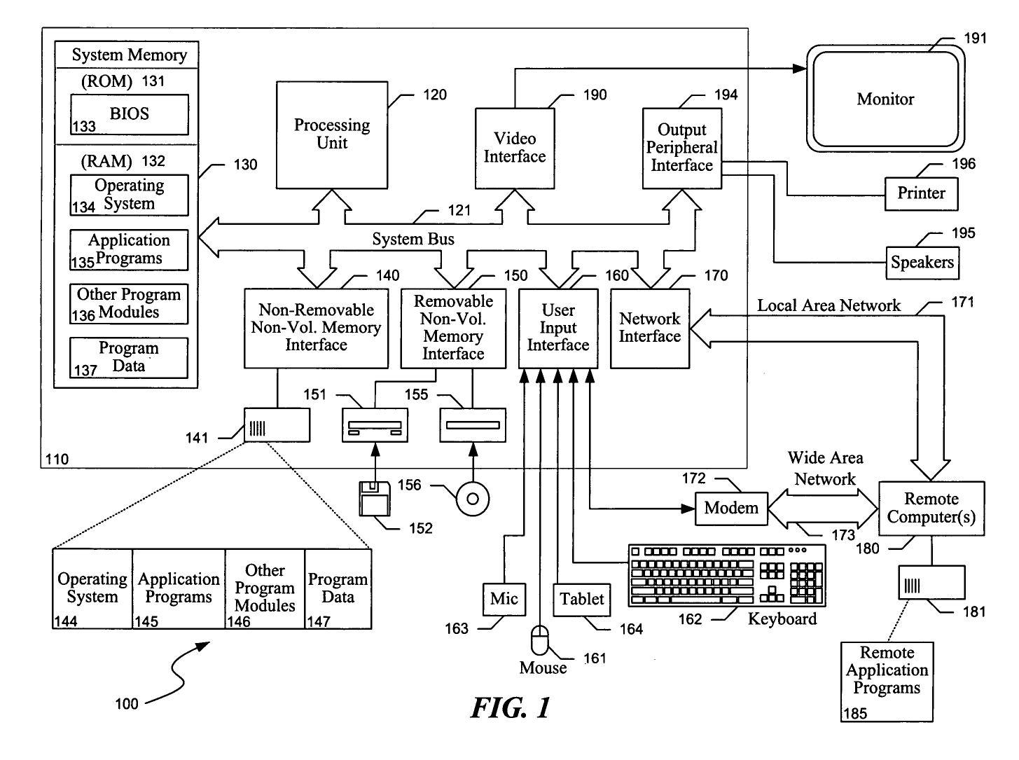

Turning now to the figures, FIG. 1 is a block diagram illustrating an example of a suitable computing system environment 110 or operating environment in which the techniques or facility may be implemented. The computing system environment 110 is only one example of a suitable computing environment and is not intended to suggest any limitation as to the scope of use or functionality of the facility. Neither should the computing system environment 110 be interpreted as having any dependency or requirement relating to any one or a combination of components illustrated in the exemplary operating environment 110.

The facility is operational with numerous other general purpose or special purpose computing system environments or configurations. Examples of well-known computing systems, environments, and/or configurations that may be suitable for use with the facility include, but are not limited to, personal computers, server computers, handheld or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The facility may be described in the general context of computer-executable instructions, such as program modules, being executed by a computer. Generally, program modules include routines, programs, objects, components, data structures, and so forth that perform particular tasks or implement particular abstract data types. The facility may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the facility includes a general purpose computing device in the form of a computer 100. Components of the computer 100 may include, but are not limited to, a processing unit 120, a system memory 130, and a system bus 121 that couples various system components including the system memory 130 to the processing unit 120. The system bus 121 may be any of several types of bus structures including a memory bus or memory controller, a peripheral bus, and a local bus using any of a variety of bus architectures. By way of example, and not limitation, such architectures include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as a Mezzanine bus.

The computer 100 typically includes a variety of computer-readable media. Computer-readable media can be any available media that can be accessed by the computer 100 and include both volatile and nonvolatile media and removable and nonremovable media. By way of example, and not limitation, computer-readable media may comprise computer storage media and communications media. Computer storage media include volatile and nonvolatile and removable and nonremovable media implemented in any method or technology for storage of information such as computer-readable instructions, data structures, program modules, or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 100. Communications media typically embody computer-readable instructions, data structures, program modules, or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communications media include wired media, such as a wired network or direct-wired connection, and wireless media, such as acoustic, RF, infrared, and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system (BIOS) 133, containing the basic routines that help to transfer information between elements within the computer 100, such as during start-up, is typically stored in ROM 131. RAM 132 typically contains data and/or program modules that are immediately accessible to and/or presently being operated on by the processing unit 120. By way of example, and not limitation, FIG. 1 illustrates an operating system 134, application programs 135, other program modules 136, and program data 137.

The computer 100 may also include other removable/nonremovable, volatile/nonvolatile computer storage media. By way of example only, FIG. 1 illustrates a hard disk drive 141 that reads from or writes to nonremovable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD-ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a nonremovable memory interface, such as an interface 140, and the magnetic disk drive 151 and optical disk drive 155 are typically connected to the system bus 121 by a removable memory interface, such as an interface 150.

The drives and their associated computer storage media, discussed above and illustrated in FIG. 1, provide storage of computer-readable instructions, data structures, program modules, and other data for the computer 100. In FIG. 1, for example, the hard disk drive 141 is illustrated as storing an operating system 144, application programs 145, other program modules 146, and program data 147. Note that these components can either be the same as or different from the operating system 134, application programs 135, other program modules 136, and program data 137. The operating system 144, application programs 145, other program modules 146, and program data 147 are given different numbers herein to illustrate that, at a minimum, they are different copies. A user may enter commands and information into the computer 100 through input devices such as a tablet or electronic digitizer 164, a microphone 163, a keyboard 162, and a pointing device 161, commonly referred to as a mouse, trackball, or touch pad. Other input devices not shown in FIG. 1 may include a joystick, game pad, satellite dish, scanner, or the like. These and other input devices are often connected to the processing unit 120 through a user input interface 160 that is coupled to the system bus 121, but may be connected by other interface and bus structures, such as a parallel port, game port, or a universal serial bus (USB). A monitor 191 or other type of display device is also connected to the system bus 121 via an interface, such as a video interface 190. The monitor 191 may also be integrated with a touch-screen panel or the like. Note that the monitor 191 and/or touch-screen panel can be physically coupled to a housing in which the computer 100 is incorporated, such as in a tablet-type personal computer. In addition, computing devices such as the computer 100 may also include other peripheral output devices such as speakers 195 and a printer 196, which may be connected through an output peripheral interface 194 or the like.

The computer 100 may operate in a networked environment using logical connections to one or more remote computers, such as a remote computer 180. The remote computer 180 may be a personal computer, a server, a router, a network PC, a peer device, or other common network node, and typically includes many or all of the elements described above relative to the computer 100, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprisewide computer networks, intranets, and the Internet. For example, in the present facility, the computer 100 may comprise the source machine from which data is being migrated, and the remote computer 180 may comprise the destination machine. Note, however, that source and destination machines need not be connected by a network or any other means, but instead, data may be migrated via any media capable of being written by the source platform and read by the destination platform or platforms.

When used in a LAN networking environment, the computer 100 is connected to the LAN 171 through a network interface or adapter 170. When used in a WAN networking environment, the computer 100 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 100, or portions thereof, may be stored in the remote memory storage device 181. By way of example, and not limitation, FIG. 1 illustrates remote application programs 185 as residing on the memory storage device 181. It will be appreciated that the network connections shown are exemplary and other means of establishing a communications link between the computers may be used.

While various functionalities and data are shown in FIG. 1 as residing on particular computer systems that are arranged in a particular way, those skilled in the art will appreciate that such functionalities and data may be distributed in various other ways across computer systems in different arrangements. While computer systems configured as described above are typically used to support the operation of the facility, one of ordinary skill in the art will appreciate that the facility may be implemented using devices of various types and configurations, and having various components.

The techniques may be described in the general context of computer-executable instructions, such as program modules, executed by one or more computers or other devices. Generally, program modules include routines, programs, objects, components, data structures, etc., that perform particular tasks or implement particular abstract data types. Typically, the functionality of the program modules may be combined or distributed as desired in various embodiments.

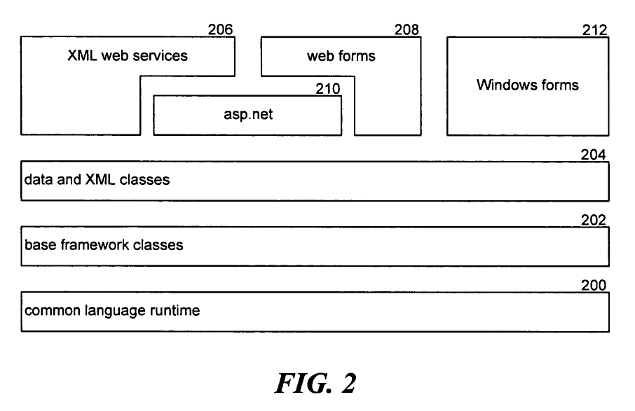

FIG. 2 is a block diagram illustrating a relationship between various .NET components. .NET includes a CLR 200. The CLR is a generalized multi-language, reflective VM on which code originally written in various programming languages runs after this code is translated into IL, such as by a compiler. Reflection is an ability offered by CLR to application programs to observe and possibly modify aspects of the application program. NET offers various base framework classes 202 that provide additional functionality to application programs. As an example, the .NET framework classes provide various methods, properties, and data types that may be commonly employed by application developers. NET may also provide various data and XML classes 204 that enable an application to access and manipulate data. Applications may also take advantage of other .NET components, such as an XML web services component 206, web forms component 208, ASP.NET component 210, and Windows forms component 212. The XML web services component provides a facility for working with XML web services. The web forms component provides a facility for working with HTML-based forms. The ASP.NET component provides a facility that the XML web services and web forms component may use, such as to retrieve data from the data and XML classes and transform the data into a form that the XML web services or web forms can consume. The Windows forms component enables applications to provide standard Windows forms, e.g., to a user.

Mapping Property Styles

A software facility (“property mapping facility”) is provided for enabling a Java language compiler to map properties defined according to a “Java Bean” style to properties defined in a .NET style. A property is a named attribute of an object, such as a member of a class. Java Bean-style properties are conventionally accessed using “accessor” methods. As an example, when the property is named “prop,” the Java Bean-style accessor methods are conventionally “getprop,” “isprop,” “setprop,” and so forth. These accessor methods retrieve or set aspects of the property. However, the Visual J# compiler may not recognize these methods as property accessor methods because .NET utilizes a different convention to identify accessor methods. Under the .NET naming convention, corresponding property accessor methods for the “prop” property would be “get_prop,” “is_prop,” and “set_prop.” When a NET language compiler, such as the Visual J# compiler, compiles source code that accesses a property (e.g., the statement “class1.prop=5”), the compiler determines whether the named attribute (e.g., “prop”) is defined to be a property by analyzing metadata. Most .NET language compilers that emit IL also generate metadata that identifies properties defined or employed by the IL and provides a list of actions that can be performed on the properties. If the named attribute is a property, the compiler generally transforms the code to the .NET naming convention (e.g., “class1.set_prop=5”). When Java Bean-style property accessor methods appear in the source code (e.g., class1.setprop), these methods would fail to compile and/or execute correctly. Consequently, the compiler needs to identify and correctly compile Java Bean-style property accessor methods appearing in source code without affecting how such source code would be compiled by non-.NET compilers. To do so, a developer annotates accessor methods in a way that would not affect compilation when using compilers that are unaware of such annotations. As an example, the developer could precede each definition of an accessor method in Java source code with the following comment: @beanproperty. Then, compilers employing the property mapping facility can transform any Java Bean-style accessor method appearing in the source code to a NET-style accessor method. Other compilers, e.g., compilers that emit Java byte code designed for use with Java VMs, could also compile the same source code. Table 1 presents an example.

TABLE 1
Mapping Property Styles Code Example

public class newproperty {

/** @beanproperty */
public int getvalue( ) {

...

}
...

...

public static void main ( ) {

...
int j = newproperty.getvalue( );
...

}

}

Table 1 contains class definition code for a “newproperty” class that has at least a “getvalue” accessor function named according to the Java Bean style. This accessor method is employed by the main method to set a value for a variable “j.” The “getvalue” function definition identifies the accessor as a Java Bean-style accessor using the comment @beanproperty. When a conventional Java compiler compiles this source code, it would continue to use the Java Bean style. However, when a compiler that is aware of this @beanproperty annotation compiles this source code, it would map the Java Bean-style property accessor to a .NET equivalent. As an example, when it encounters the instruction “int j=newproperty.getvalue( )”, the compiler would map the instruction to “int j=newproperty.get_value( )” because that is the NET convention.

In some embodiments, annotations appear immediately before the definition of the accessor methods. In some embodiments, annotations appear immediately after the definition of the accessor methods. In some embodiments, annotations appear near the definition of the accessor methods.

Annotating source code is advantageous as compared to modifying the source code to change all accessor methods to the NET-style accessor methods because modifying source code could introduce various compilation errors, whereas adding comments is less likely to do so. Moreover, developers may only need to add the annotation once, such as when the accessor method is defined. In some embodiments, developers can annotate every appearance of the accessor methods in the source code. In any of these embodiments, the annotations can be applied to various types of Java properties.

In various embodiments, developers can employ other annotations to specify coding styles. As an example, the technique can be employed to convert NET-style accessor methods to another style by indicating a “@dotNETproperty” annotation when the NET-style accessor methods are defined. When a compiler encounters such annotations, it may map a .NET-style property accessor method to another style. In various embodiments, developers can employ multiple styles simultaneously. As an example, developers may provide a NET-style accessor method and a Java Bean-style accessor method in their source code. When mapping to a third style of accessor method or when compiling for a specific other VM or CLR, the compiler may utilize the annotations as an aid in locating accessor methods.

In some embodiments, developers can employ this technique to map any method from one style to another style, and not just property accessor methods.

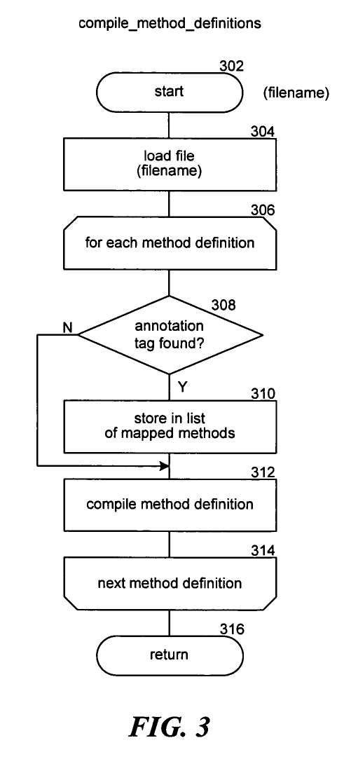

FIG. 3 is a flow diagram illustrating a compile method_definitions routine employed by a property mapping facility in various embodiments. The routine begins at block 302 where it receives an indication of a source code file as a parameter. At block 304, the routine loads the indicated file.

Between the loop of blocks 306 and 314, the routine processes method definitions indicated in the loaded file. At block 306, the routine selects a method definition.

At block 308, the routine determines whether an annotation tag is found. As an example, the routine determines whether a “@beanproperty” appears before the selected method. In various embodiments, the routine determines whether the annotation tag appears within or after the selected method. If the annotation tag is found, the routine continues at block 310. Otherwise, the routine continues at block 312.

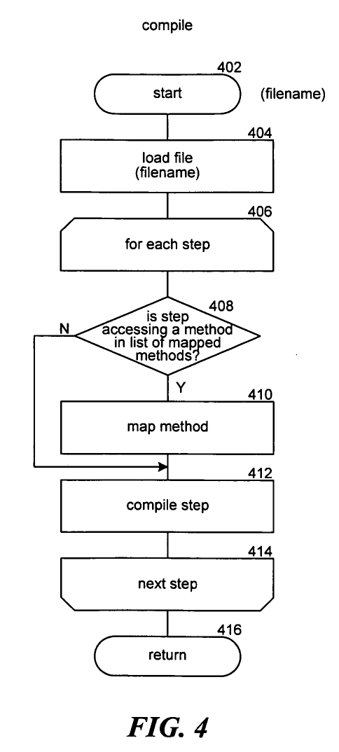

At block 310, the routine stores the selected method in a list of mapped methods. This list is used in a later compilation step, which is described in further detail below in relation to FIG. 4.

At block 312, the routine compiles the method definition as it would do conventionally.

At block 314, the routine selects another method. When all methods have been processed, the routine continues at block 316, where it returns. Otherwise, the routine continues at block 308.

FIG. 4 is a flow diagram illustrating a compile routine performed by a property mapping facility in various embodiments. The routine begins at block 402 where it receives an indication of a file as a parameter.

At block 404, the routine loads the indicated file.

Between the loop of blocks 406 and 414, the routine analyzes steps within the file to determine whether the steps access a method that was processed by the compile_method_definitions routine of FIG. 3. At block 406, the routine selects a step.

At block 408, the routine determines whether the step accesses a method that appears in the list of mapped methods created by the compile_method_definitions routine of FIG. 3. If the step accesses a method that appears in the list of mapped methods, the routine continues at block 410. Otherwise, the routine continues at block 412.

At block 410, the routine maps the method. As an example, if the method is a property accessor and the method name may correspond to a Java-Bean style method name, the routine may map the method to a NET-style property accessor method.

At block 412, the routine compiles the step as it conventionally would.

At block 414, the routine selects another step. When all steps in the file have been processed, the routine continues at block 416, where it returns. Otherwise, the routine continues at block 408.

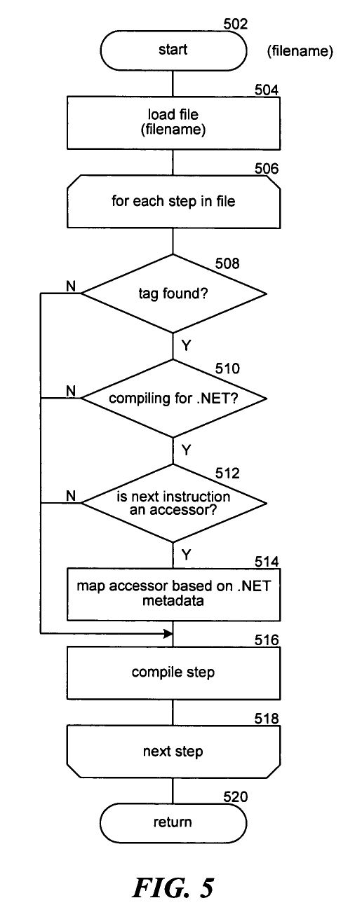

FIG. 5 is a flow diagram illustrating a compile routine invoked by a property mapping facility in an alternate embodiment. In contrast to the compile routine of FIG. 4, the compile routine illustrated in FIG. 5 searches for annotation tags near each accessor method and not just near the accessor method's definition. The routine begins at block 502 where it receives an indication of a file as a parameter.

At block 504, the routine loads the indicated file.

Between the loop of blocks 506 and 518, the routine maps accessors to another style, as appropriate. At block 506, the routine selects a step in the indicated file.

At block 508, the routine determines whether the step indicates an annotation tag. When the step indicates an annotation tag, the routine continues at block 510. Otherwise, the routine continues at block 516.

At block 510, the routine determines whether it is compiling for .NET. When the routine is compiling for NET, the routine continues at block 512. Otherwise, the routine continues at block 516.

At block 512, the routine determines whether the next instruction is an accessor. When the next instruction is an accessor, the routine continues at block 514. Otherwise, the routine continues at block 516.

At block 514, the routine maps the accessor based on .NET metadata. As an example, the routine may emit code to invoke a .NET accessor method.

In various embodiments, the routine may determine whether it is compiling for other platforms and emit code appropriate for the other platforms.

At block 516, the routine compiles the step as it conventionally would.

At block 518, the routine selects another step. If all steps have been processed, the routine continues at block 520, where it returns. Otherwise, the routine continues at block 508.

Parameters by Reference

A software facility (“reference mapping facility”) is provided for enabling a Java language compiler to detect an indication to pass parameters by reference and emit corresponding code. The Java language does not provide developers with an ability to provide references to objects as parameters for methods or functions (collectively, “methods”). As an example, the Java language does not have the concept of “pointers.” When an object is provided by reference to a method, the method can manipulate members of the object such that the manipulations are visible outside the scope of the method. Table 2 provides an example.

TABLE 2
Swap Method

public void swap (int v1, int v2) {

int temp = v1;
v1 = v2;
v2 = temp;

}

Suppose that an application invoking the swap method provides two variables as parameters and the value of the variable corresponding to v1 is 10 and the value of the variable corresponding to v2 is 20. After invoking the method, the values of the provided two variables would be unchanged in the Java language. Even when v1 and v2 are defined to be objects, their members' values would remain unchanged. This occurs because the Java language considers parameters to be passed by value and not by reference. As a result, various types of methods, such as the swap method, cannot be written in the Java language without the use of an external facility. Another example of a type of method that generally requires parameters to be provided by reference includes functions of an operating system that handle message queues, such as the MICROSOFT WINDOWS “message pump,” which is commonly referred to as WinProc.

The mapping facility enables parameters to be passed by reference by adding a reference annotation to the Java language. Table 3 provides an example of the swap method with the reference annotation.

TABLE 3
Swap Method With Reference Annotation

public void swap (

/** @ref */ int v1,
/** @ref */ int v2)

{

int temp = v1;
v1 = v2;
v2 = temp;

}

The swap method of Table 3 is similar to the swap method of Table 2 except that it additionally has the @ref annotation associated with both of its parameters. The annotation can be associated with any or all of a method's parameters when the method is defined. When the @ref annotation is associated with a parameter, the reference mapping facility causes the compiler to emit object code (e.g., IL) that employs the objects indicated by the parameters by reference rather than by value. As an example, the compiler can push the addresses of the parameters onto a stack rather than their values when compiling instructions that invoke the method. In such a case, the method can correctly manipulate the objects indicated by the parameters, such as to swap the values indicated by v1 and v2 in this example. The compiler indicates in metadata that the annotated parameters are to be provided by reference. When the compiler compiles other steps in the source code, it detects from this metadata whether the parameter is to be provided by reference or value.

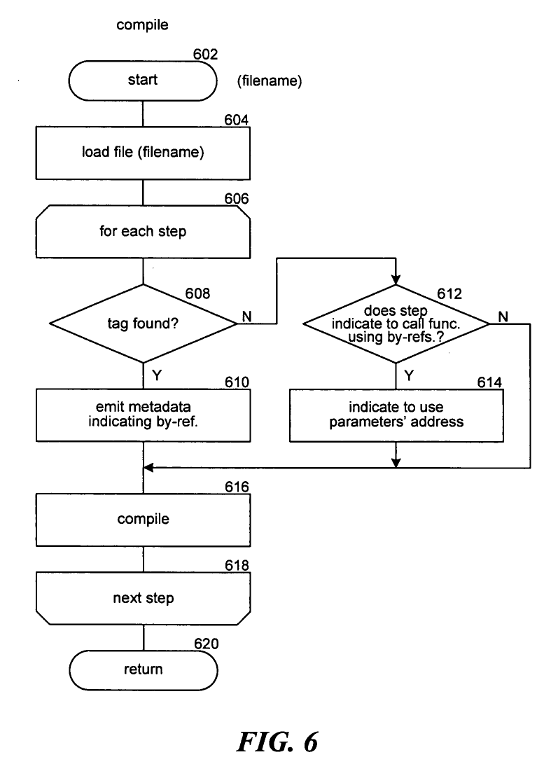

FIG. 6 is a flow diagram illustrating a compile routine invoked by a reference mapping facility in various embodiments. The routine enables a compiler to detect that a developer desires to provide parameters by reference and emit appropriate IL. The routine begins at block 602 where it receives an indication of a file as a parameter.

At block 604, the routine loads the indicated file.

Between the loop of blocks 606 and 618, the routine processes the steps (e.g., program instructions in source code) in the indicated file. At block 606, the routine selects a step from the file. As an example, the routine selects “public void swap (/@ref */ int v1, /** @ ref */ int v2)” from the file.

At block 608, the routine determines whether the step contains an annotation tag. As an example, the routine determines whether the step contains an annotation tag indicating that a parameter is to be provided by reference. In some embodiments, this annotation tag is “@ref” and appears within a comment adjacent to a parameter appearing in the definition of a method. When the step contains the annotation tag, the routine continues at block 610. Otherwise, the routine continues at block 612.

At block 610, the routine emits metadata indicating that the parameter is to be provided by reference. In various embodiments, this metadata is stored with the compiled IL.

At block 612, the routine determines whether the step calls a method or function that has previously been indicated as requiring parameters by reference. When that is the case, the routine continues at block 614. Otherwise, the routine continues at block 616.

At block 614, the routine indicates to use parameters by reference. As an example, the routine emits IL during compilation to indicate that parameters are to be provided by reference. Some parameters of a method may be provided by reference while others are provided by value.

At block 616, the routine compiles the step as it conventionally would.

At block 618, the routine selects another step. If the routine has processed all the steps in the file, the routine continues at block 620, where it returns. Otherwise, the routine continues at block 608.

Extending Declarative Type Modifiers

A software facility (“type extension facility”) is provided for enabling a Java language compiler to extend the number of declarative type modifiers that the compiler supports. The Java language provides a set of declarative type modifiers, including “public,” “private,” and “final.” These type modifiers cause the compiler or VM to impose restrictions on how an object is used. The Java language does not provide developers with an ability to extend these declarative type modifiers. However, the type extension facility provides developers with an ability to extend type modifiers and enables developers to thereby use powerful data-driven programming techniques. As an example, developers can change attributes relating to a declarative type to change application program behavior. The extension facility enables a developer to provide information about how the type is to be modified (“authoring a declarative type modifier”) and then attach the declarative type modifier to language elements. In some embodiments, the type extension facility enables a developer to author a declarative type modifier by first adding an annotation and then providing a class definition that extends a “System.Attribute” class provided by the NET Framework. The System.Attribute class is a NET base class for custom attributes. Table 4 provides an example of authoring a declarative type modifier.

TABLE 4
Authoring a Declarative Type Modifier

/** @attribute System.AttributeUsage(

AttributeTargets.All,
Inherited = false,
AllowMultiple = true) */

public class MyAttrib extends System.Attribute
{

public MyAttrib(int i)
{

value = i;

}
private int value;

}

The “@attribute” annotation tag indicates that the class definition following the annotation tag is a declarative type modifier (e.g., a custom attribute). The System.AttributeUsage portion of the annotation tag defines attributes relating to the modifier, such as attribute targets, inheritance, and ability to apply multiple instances of the modifier.

Modifiers can attach to various Java language elements, such as assemblies, modules, classes, constructors, delegates, enumerated types, events, fields, interfaces, methods, parameters, properties, return values, and so forth. The AttributeTargets value property indicates which of these language elements the modifier can attach to. The “All” value indicates that the modifier attaches to all of these language elements.

Descendant modifiers can inherit from modifiers. The “Inherited” Boolean property indicates whether or not descendants can inherit from the attribute.

The type extension facility may also provide an “AllowMultiple” Boolean property using which a developer can indicate whether multiple instances of the modifier can be indicated for a particular language element.

Furthermore, modifiers can receive parameters that specify additional information associated with code elements that they modify, thereby enabling further data-driven programming. By providing custom modifiers, the type extension facility enables a developer to easily extend aspects of the Java programming language.

Table 5 provides an example of attaching the declarative type modifier to language elements.

TABLE 5
Attaching a Declarative Type Modifier

/** @attribute MyAttrib (“String”) */

public class MyClass
{

...

}

As is evident from Table 5, a developer can attach the modifier to a Java language element (e.g., a class) by indicating the modifier, such as by adding an annotation tag immediately before the definition of the class that is to be modified. In some embodiments, the developer indicates the modifier after the class definition or within the class definition. The developer can also provide any parameters the modifier expects, such as “String” in the example provided in Table 5.

When a compiler encounters the “@attribute System.AttributeUsage” modifier definition when compiling source code, it adds metadata associated with the application program being compiled. The metadata indicates the custom modifier's information defined by the developer. When the compiler encounters the “@attribute” custom modifier when compiling source code, it reads metadata associated with the custom modifier and emits the necessary IL.

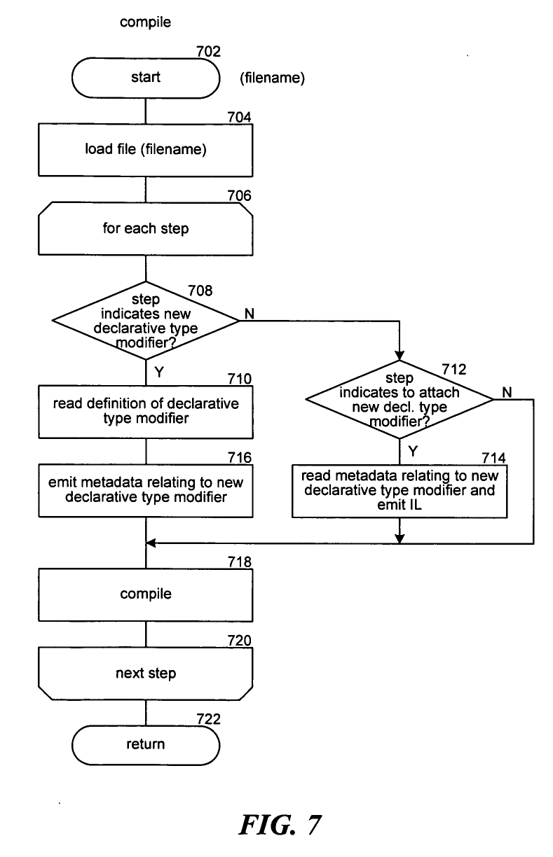

FIG. 7 is a flow diagram illustrating a compile routine invoked by a type extension facility in various embodiments. The type extension facility invokes the compile routine during compilation of source code to enable extended declarative type modifiers. The routine begins at block 702 where it receives an indication of a file as a parameter.

At block 704 the routine loads the indicated file.

Between the loop of blocks 706 and 720, the routine processes the steps in the indicated file. At block 706 the routine selects a step.

At block 708, the routine determines whether the step indicates that a new declarative type modifier is being added. The step may indicate that a new declarative type modifier is being added by providing an annotation tag adjacent to a class definition that conforms to various rules. As an example, the step may indicate a new declarative type modifier by providing an “@attribute System.AttributeUsage( . . . )” tag adjacent to a class definition that is indicated to extend a System.Attribute class. If the step indicates that a new declarative type modifier is being added, the routine continues at block 710. Otherwise, the routine continues at block 712.

At block 710, the routine reads the definition of the declarative type modifier and continues at block 716, where it emits metadata relating to the new declarative type modifier.

At block 712, the routine determines whether the step indicates to attach the new declarative type modifier. As an example, the step may indicate to attach the new declarative type modifier by providing an “@attribute” tag adjacent to the definition of an object, such as a new class. If the step indicates to attach the new declarative type modifier, the routine continues at block 714. Otherwise, the routine continues at block 718.

At block 714, the routine reads metadata relating to the new declarative type modifier and emits corresponding IL. The routine then continues at block 718.

At block 718, the routine compiles the step as it would conventionally.

At block 720, the routine selects another step. If all steps have been processed, the routine continues at block 722 where it returns. Otherwise, the routine continues at block 708.

Partial Classes

A software facility (“partial class facility”) is provided for enabling a Java language compiler to postpone compiling a class marked as partial until the compiler can load and compile the entire class. Compilers generally have access to an entirety of a class's definition when they compile the class. As an example, the entire class's definition may be in a source code file or multiple source code files that are linked together, such as by using “include” statements. However, it may be beneficial to split up class definitions into multiple source code files. As an example, when a developer employs a graphical forms designer of an IDE, the forms designer may emit source code relating to the visual aspects of forms. Moreover, the developer may manually input source code associated with logical aspects of the forms. Partial classes cannot be individually compiled because the compiler could encounter errors, such as when one portion of the partial class references another portion that is defined in the other partial class. As an example, when code associated with the logical aspect of a form references a property associated with a form field that is defined by a forms designer, the compiler may fail when the code and property appear in different source code files. The Java language has no concept of partial classes and thus has no ability for developers to indicate partial classes.

The partial class facility introduces a partial class annotation. When a Java language compiler encounters the partial class annotation, it postpones compiling the class until all files that are to be compiled have been loaded. As an example, two files may each contain a portion of a class's definition. The first file may be generated by a graphical forms designer and the second may be input by a developer. In some embodiments, both files may contain a “@partial” annotation, such as near the beginning of the class's definition and embedded in a comment. Then when a compiler encounters the first file, it may postpone compiling the file until all other files have been loaded and/or processed. As a result, compiling the class will not fail because its entire definition is not loaded.

Tables 6 and 7 identify partial classes identified by the “@partial” annotation and Table 8 identifies the full class, such as after the compiler has loaded source code files corresponding to Tables 6 and 7.

TABLE 6
Partial Class in File 1

/** @partial */

public class MyClass
{

public void method1( ) {

...

}

}

TABLE 7
Partial Class in File 2

/** @partial */

public class MyClass
{

public void method2( ) {

...

}

}

TABLE 8
Compiler's Union of Partial Classes

public class MyClass
{

public void method1( ) {

...

}
public void method2( ) {

...

}

}

In some embodiments, the “@partial” annotation is not required for one of the portions of the class, such as one of the source code files.

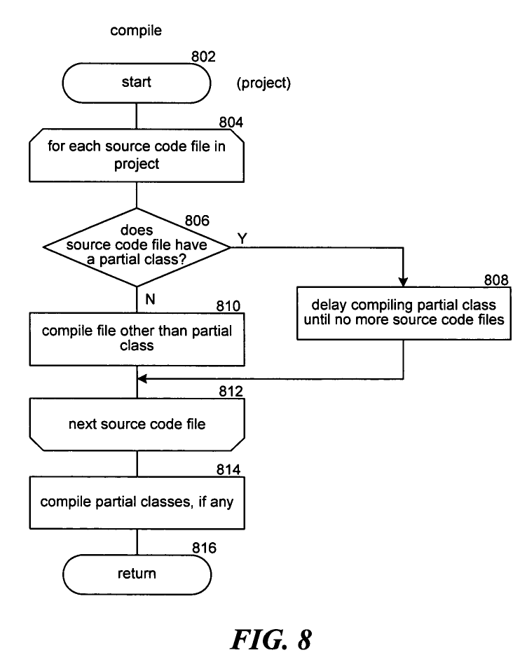

FIG. 8 is a flow diagram illustrating a compile routine invoked by a partial class facility in various embodiments. The partial class facility invokes the compile routine during compilation of source code in which portions of classes are located in separate files. The routine begins at block 802 where it receives an indication of a project as a parameter. A project indicates at least a set of source code files.

Between the loop of blocks 804 and 812, the routine processes the source code files. At block 804, the routine selects and loads a source code file of the indicated project.

At block 806, the routine determines whether the loaded source code file contains a partial class. A loaded source code file contains a partial class when it contains a partial class annotation tag near a class definition. As an example, a source code file contains a partial class when it is preceded by a “@partial” annotation tag that is embedded in a comment. If the loaded source code file contains a partial class, the routine continues at block 808. Otherwise, the routine continues at block 810.

At block 808, the routine adds the loaded source code file to a list of source code files whose compilation has been postponed until all source code files that do not contain partial classes have been processed. The routine then continues at block 812.

At block 810, the routine compiles the loaded source code file.

At block 812, the routine selects another source code file. If all source code files have been processed, the routine continues at block 814. Otherwise, the routine continues at block 806.

At block 814, the routine compiles all source code files that were indicated to be postponed at block 808. Thus, the routine postpones compilation of all source code files containing partial classes until such files can be processed together.

At block 816, the routine returns.

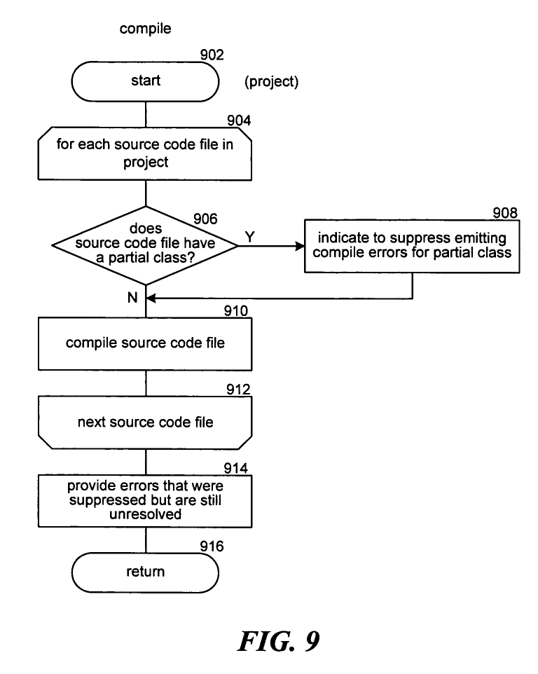

FIG. 9 is a flow diagram illustrating a compile routine invoked by the partial class facility in alternate embodiments. In these alternate embodiments, rather than postponing the compiling of source code files containing partial classes, the compiler postpones emitting compilation errors until all source code files have been processed. The routine begins at block 902 where it receives an indication of a project as a parameter.

Between the loop of blocks 904 and 912 the routine processes the source code files of the project. At block 904, the routine selects a source code file of the project.

At block 906, the routine determines whether the selected source code file contains a partial class, in a manner similar to the logic of block 806 of FIG. 8. If the selected source code file contains a partial class, the routine continues at block 908. Otherwise, the routine continues at block 910.

At block 908, the routine sets an indication that compilation errors relating to missing portions of a partial class are to be postponed for the selected source code file. The routine then continues at block 910.

At block 910, the routine compiles the selected source code file. If the routine previously indicated at block 908 that compilation errors relating to missing portions of a partial class are to be postponed for this selected source code file, the partial class facility suppresses emitting the errors and resets the indication. Otherwise, the routine emits all compilation errors.

At block 912, the routine selects another source code file. If all source code files of the project have been processed, the routine continues at block 914. Otherwise, the routine continues at block 906.

At block 914, the routine provides all errors that were suppressed but remain unresolved. As an example, if the routine encountered several partial classes but at least one of the partial classes was not completed by any of the source code files of the project, the routine provides errors relating to the incomplete partial class. In various embodiments, the routine may additionally need to recompile the source code files containing partial classes, such as when the partial class in one of the source code files refers to members of the class appearing in another source code file.

At block 916, the routine returns.

Value Types

A software facility (“value type facility”) is provided for enabling a Java language compiler to recognize “value types.” Value types may also be referred to as “light weight” classes, and offer a developer an ability to place data types the developer defines onto a stack instead of a heap and thereby take advantage of features offered by both primitive and reference data types. Conventionally, the Java language recognizes two types of data: “primitive” and “reference” types.

Primitive types are simple data types that programming languages define, such as byte, integer, floating point, Boolean, and character, and a variable defined to be a primitive data type contains a value corresponding to its data type. In the Java programming language, primitive types are placed onto a stack when they are used and are automatically removed from the stack when their “scope” expires. A variable's scope expires when the variable can no longer be used.

A reference data type is a more complex or composite data type that generally requires source code to provide a definition. Reference data types in Java include arrays, classes, and interfaces. A variable defined to be a reference data type generally contains a memory address corresponding to the memory location where the data resides. Nevertheless, as previously discussed herein, the Java programming language conventionally does not support the express use of these references. In the Java programming language, reference types are placed in a memory heap when they are created. A garbage collection process periodically cleans from the heap reference types that applications can no longer use. Use of reference types can degrade an application's performance because the system must find space on the heap when a reference type is created. Furthermore, the application may appear to be paused when the garbage collector operates to clean the heap.

Primitive and reference data types differ in their assignment semantics. Tables 9 provides an example.

TABLE 9
Assignment Semantics

public void testPrimitiveType ( ) {

int i, j;
i = 5;
j = i;
i = 10;

}
public void testReferenceType ( ) {

Point pi, pj;
pi.x = 5;
pj = pi;
pi.x = 10;

}

Upon executing the testPrimitiveType method, the value of the variable j is 5 because the Java VM has copied the contents of variable i into the variable j when j was assigned i by the statement “j=i.” However, upon executing the testReferenceType method, the value of the variable pj.x is 10 because the Java VM has caused the variable pj to point to the same structure as the variable pi when pj was assigned pi by the statement “pj=pi.” Thus, both pi and pj reference the same Point object because assignment semantics for reference types are different in Java than assignment semantics for primitive types.

The value type facility adds value types to the Java language. A value type is similar to a reference type in that a developer defines the value type, such as by defining a class. A value type is also similar to a primitive type in that the assignment semantics of value types apply and value types are created on a stack. Furthermore, value types have similar scope to primitive types and do not need to be removed by a garbage collector.

To enable developers to create and use value types, the value type facility in various embodiments employs a System.ValueType class. In these embodiments, value types extend the System.ValueType class. Furthermore, value types are declared “final” and are indicated to be “public,” “private,” or “protected.” In some embodiments, the System.ValueType class provides the necessary logic to enable value types. Table 10 provides an example of a definition of a value type object.

TABLE 10
Assignment Semantics

public final class Point extends System.ValueType
{

public int x;
public int y;
public Point(int i, int j)
{

x = i;
y = j;

}

}

Now upon executing the testReferenceType method, the value of the variable pj.x is 5 (instead of 10, as would be the case when using reference types) because the .NET CLR applies the assignment semantics for primitive types.

The value type facility also enables a developer to convert a value type into a reference type via a “boxing” operation and to convert a reference type into a value type via an “unboxing” operation. The developer may use the boxing and unboxing operations, e.g., to take advantage of features offered by reference types or value types. In the Java language, the developer merely copies a variable of one data type to another data type, e.g., by using an assignment operator, and the value type facility automatically boxes or unboxes as required.

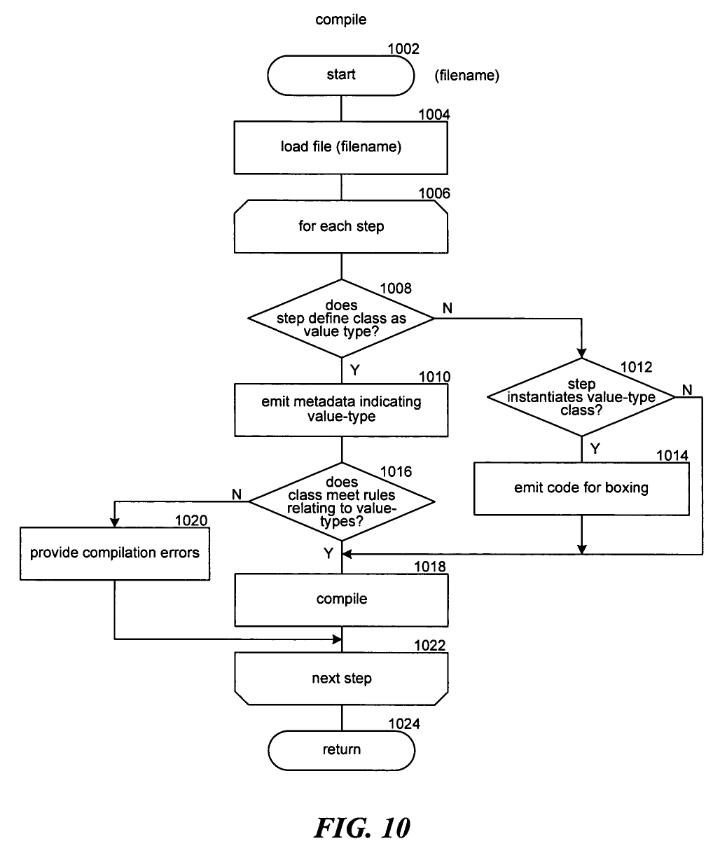

FIG. 10 is a flow diagram illustrating a compile routine invoked by a value type facility in various embodiments. The value type facility invokes the routine to enable the addition of value types during compilation of an application program or other software component. The routine begins at block 1002 where it receives an indication of a file as a parameter.

At block 1004, the routine loads the indicated file.

Between the loop of blocks 1006 and 1022, the routine processes the steps in the source code of the indicated file. At block 1006, the routine selects a step to process.

At block 1008, the routine determines whether the selected step defines a class as a value type. A step can define a class as a value type in a number of ways. As an example, a step can define a class as a value type by declaring the class to be “final” and extending (e.g., inheriting from) a “System.ValueType.” The value type facility may provide a System.ValueType class, e.g., in its framework class. If the selected step defines the class as a value type, the routine continues at block 1010. Otherwise, the routine continues at block 1012.

At block 1010, the routine emits metadata indicating that the class that is being defined is a value type. The routine then continues at block 1016.

At block 1012, the routine determines whether the step instantiates a class that was previously defined to be a value type. If the class was previously defined to be a value type, the routine continues at block 1014. Otherwise, the routine continues at block 1018.

At block 1014, the routine emits IL for boxing the value type object. When a value type object is boxed, it can be used with reference types. In some embodiments, the routine may not box the value type object. The routine then continues at block 1018.

At block 1016, the routine optionally determines whether the defined class meets rules relating to value types. As an example, value types may need to be declared as “final.” When the defined class meets these rules, the routine continues at block 1018. Otherwise, the routine continues at block 1020.

At block 1018, the routine compiles the selected step as it conventionally would.

At block 1020, the routine provides indications of compilation errors. As an example, the routine may indicate that the defined class does not meet at least one of the rules relating to value types. The routine then continues at block 1022.

At block 1022, the routine selects another step from the indicated file. When all the steps of the indicated file have been processed, the routine continues at block 1024 where it returns. Otherwise, the routine continues at block 1008.

Bridging Semantically Different Event Technologies

A software facility (“event bridge facility”) is provided for bridging semantically different event technologies. An event is a message that an event source sends to an event sink. An event source is an object that “fires” or sends events. An event sink is an object that handles events fired by the event source. Typically, event sinks register with event sources to receive events. In some event technologies, such as Java Beans-style events, the event source and event sink are said to be “tightly coupled.” When the event source and event sink are tightly coupled, they each employ a common or shared interface. As an example, event sinks that use Java Bean-style events may inherit an interface from a “java.util.EventListener” interface defined by a Java library. In other event technologies, such as MICROSOFT Component Object Model (COM), the event source and event sink are said to be “loosely coupled.” When the event source and event sink are loosely coupled, the event sink implements a set of functions that an event source can invoke through a dynamic method invocation mechanism. As an example, a COM event sink implements an IDispatch interface that an event source employs to discover other methods of the event sink to invoke.

The event bridge technology enables an event source object to fire events that a “type-unsafe” event sink object can receive. An event sink object is type-unsafe when it is loosely coupled because it is unaware of the interface provided by the event source. The event bridge facility first obtains the set of events supported by an event source object using a reflection mechanism. Reflection enables a software component to find at run time information relating to objects contained in an assembly. As an example, a Java component can utilize a java.lang.reflect application program interface (API) to discover this information. Alternatively, a .NET component can utilize a System.Reflection API to discover this information. The event bridge facility next dynamically generates an implementation of a class or other object for each of the events discovered through reflection. It does so by employing dynamic code generation support offered by the underlying environment in which either the event source or event sink objects operate. As an example, a NET component can employ a System.Reflection.Emit API to dynamically generate the implementation, such as by emitting a class that handles the events. The generated implementation invokes methods provided by an event sink object. As an example, the generated implementation invokes the IDispatch method provided by a COM-based event sink object. To ensure that the generated implementation is type-safe, the event bridge facility derives the generated implementation from a type that the event source object expects. The event bridge facility next registers an instance of the generated implementation with the event source object. When the event source object fires an event, the generated implementation routes the event to the type-unsafe event sink by invoking a dynamic invocation mechanism of the event sink object. As an example, it invokes the IDispatch::Invoke( ) method of the event sink object. Once the event bridge facility builds the bridge, the event source object can fire events that the generated implementation routes to the type-unsafe event sink object.

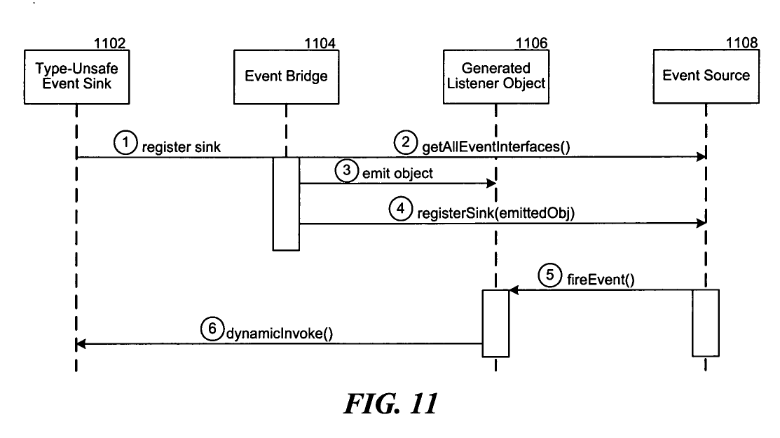

FIG. 11 is a control flow diagram illustrating a flow of logical control between various components of an event bridge facility in various embodiments. The logical control can flow as follows:

(1) A “type-unsafe” event sink object 1102 attempts to register itself with an event source object 1108.

(2) When this occurs, an event bridge object 1104 provided by the event bridge facility obtains the set of events supported by the event source object, such as by invoking a “reflection” feature of CLR.

(3) The event bridge object then dynamically emits a generated listener object 1106. The generated listener object contains code that receives events from the event source object in a type-safe manner and invokes a corresponding method of the type-unsafe event sink object.

(4) Upon generating the listener object, the event bridge facility registers the generated listener object with the event source object.

(5) Thereafter, when the event source object generates an event,

(6) The generated listener object invokes a “dynamicInvoke” method provided by the type-unsafe event sink object.

In some embodiments, the event bridge facility bridges events between a script language, such as JavaScript, and an applet or control that is implemented as a COM object.

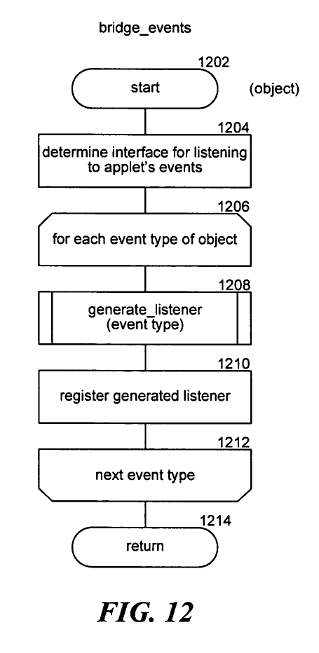

FIG. 12 is a flow diagram illustrating a bridge_events routine invoked by an event bridge facility in various embodiments. The routine begins at block 1202 where it receives an event source object as a parameter. As an example, the routine receives an indication of an applet as a parameter.

At block 1204, the routine determines the interface required for listening to the applet's events. As an example, the routine invokes a reflection feature of CLR to determine the applet's interfaces for firing events.

Between the loop of blocks 1206 and 1212, the routine processes each of the types of events the object provides. At block 1206, the routine selects an event type.

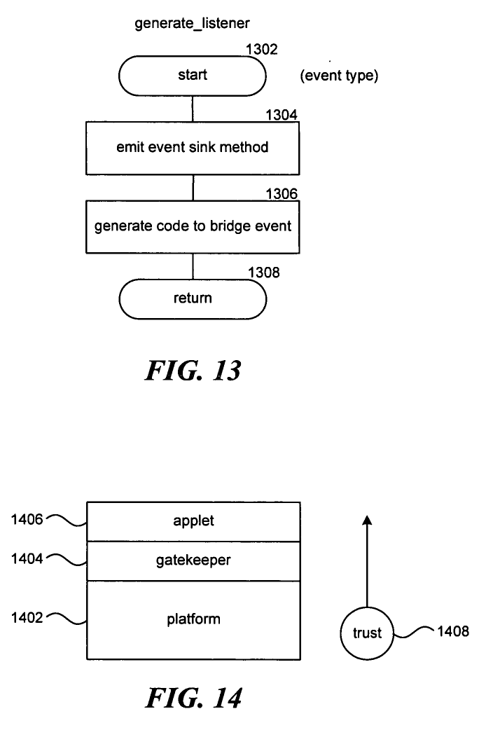

At block 1208, the routine invokes a generate_listener subroutine to generate a listener object. This subroutine is further described below in relation to FIG. 13. The routine may provide an indication of the selected event type to the generate_listener subroutine.

At block 1210, the routine registers the generated listener object with the indicated event source object.

At block 1212, the routine selects another event type. If the routine has processed all event types supported by the event source object, the routine continues at block 1214 where it returns. Otherwise, the routine continues at block 1208.

FIG. 13 is a flow diagram illustrating a generate_listener routine performed by the event bridge facility in various embodiments. The generate_listener routine may be invoked by the bridge_event routine described above in relation to FIG. 12. The routine begins at block 1302 where it receives an indication of an event type as a parameter.

At block 1304, the routine emits an event sink method corresponding to the indicated event type. This event sink method is added to a listener object that the routine creates if such an object has not already been created.

At block 1306, the routine emits code to bridge the event. In various embodiments, the routine adds code to dynamically invoke a dynamic invocation method provided by the tight-unsafe event sink object that will ultimately handle the events.

At block 1308, the routine returns.

Custom Security Semantics

A software facility (“custom security facility”) is provided for enforcing custom security semantics on components. Although .NET does not allow one software component (“application”) to load other software components, such as controls or applets, the application may contain loader code to load other software components, such as from a local hard disk. When this loader code loads the software component, the software component could be provided with more trust than intended by a software developer or user. Thus, such software components can potentially produce malicious or unintended effects. The custom security facility provides custom security semantics that honor the semantics of an underlying platform (e.g., the CLR), while ensuring that any software components that are loaded by another software component do not grant the default trust level provided to the loaded software component by the underlying platform.

The custom security facility provides a gatekeeper between a hosting environment for software components and the software components that the hosting environment loads, such as controls. The custom security facility calculates permissions that it should provide to the software components that the hosting environment loads. When the underlying platform first loads a software component under command of the hosting environment, it calculates a set of permissions to provide to the loaded software component. As examples, the underlying platform may evaluate “evidence,” such as the software component's or hosting environment's location, digital signature, and so forth. The gatekeeper can control what evidence is provided to the underlying platform to cause the underlying platform to calculate an appropriate set of permissions. By removing some evidence, the gatekeeper can cause the underlying platform to provide reduced permissions to the software component that is loaded. The gatekeeper removes sufficient evidence and invokes an API of the underlying platform to calculate appropriate permissions for the software component that is loaded.

FIG. 14 is a block diagram illustrating how trust flows through a custom security facility in various embodiments. A trust set 1408 is computed by a platform 1402, such as based on evidence provided by a gatekeeper 1404, applet 1406, or hosting environment. As an example, the applet may provide evidence relating to itself, such as its location, digital signature, and so forth. The gatekeeper may receive this evidence from the applet, transform it, and provide it to the platform such that the platform provides a desired level of trust to the applet.

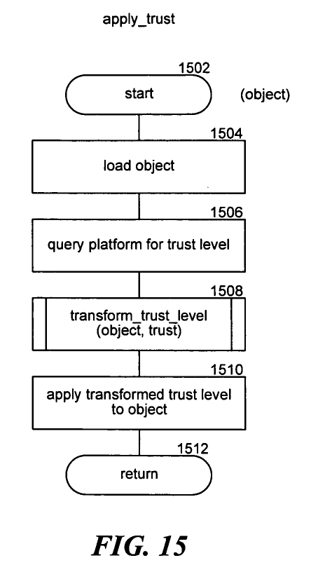

FIG. 15 is a flow diagram illustrating an apply_trust routine invoked by the custom security facility in various embodiments. A gatekeeper component of the custom security facility invokes the apply_trust routine when a hosting environment loads an object, such as an applet or control. The routine begins at block 1502 where it receives an indication of an object as a parameter. As examples, the routine may receive an indication of an applet or a control as a parameter.

At block 1504, the routine loads the indicated object. As an example, the routine may load the object from a local hard disk or other memory location.

At block 1506, the routine queries the underlying platform for a trust level associated with the object. As an example, the routine may invoke an API provided by CLR to calculate a trust level that CLR would apply to the object based on evidence associated with the object.

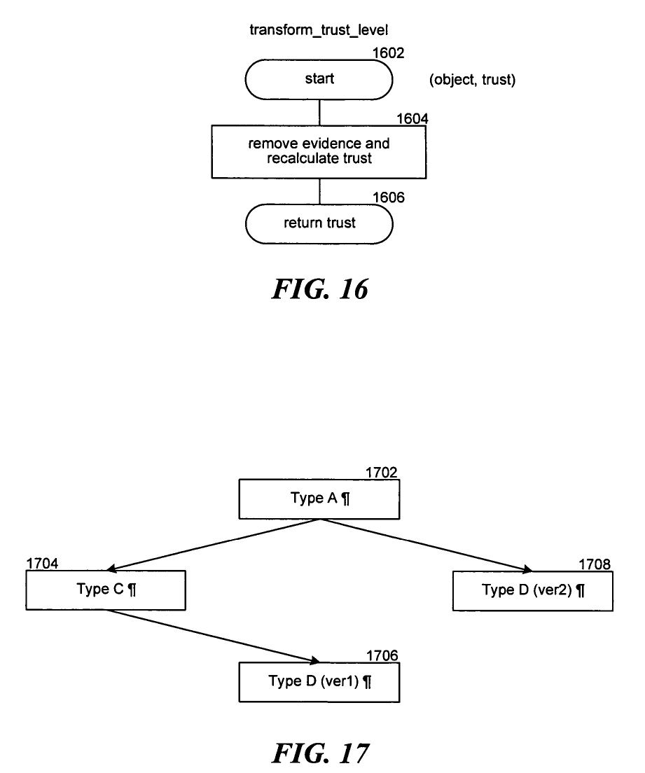

At block 1508, the routine invokes a transform_trust_level subroutine to transform the trust level provided by the underlying platform. The transform_trust_level subroutine is further described below in relation to FIG. 16. In some embodiments, the routine provides an indication of the object and the trust level indicated by the underlying platform to the subroutine and receives an indication of a recalculated trust level from the subroutine.

At block 1510, the routine applies the returned transformed trust level to the indicated object.

At block 1512, the routine returns.

FIG. 16 is a flow diagram illustrating a transform_trust_level routine performed by the custom security facility in some embodiments. The transform_trust_level routine may be invoked by the apply_trust routine described above in relation to FIG. 15. The transform_trust_level routine begins at block 1602 where it receives an indication of an object and a trust level as parameters.

At block 1604, the routine removes evidence associated with the indicated object and recalculates a trust level for the object. As an example, the routine may remove the digital signature or location information associated with the object and request the underlying platform to recalculate a trust level for the object based on the remaining evidence that was not removed. In various embodiments, the routine may invoke an API provided by CLR to calculate trust levels.

At block 1606, the routine returns the recalculated trust level.

Version-Aware Compilation

A software facility (“version-aware compilation facility”) is provided for providing errors during compilation when incorrect versions of types are used. The Java programming language does not conventionally support the concept of versioning of data types. As a result, Java compilers do not conventionally check for versions during compilation. When a language employs indirect references, it becomes possible for a software developer to inadvertently employ different versions of the same type. To determine such problems during compilation, the compiler needs to evaluate compatibility. In various embodiments, the version-aware compilation facility checks the version numbers of “assemblies” (e.g., dynamic link libraries or other software components) that provide types. The version-aware compilation facility assumes that a later version number is compatible with an earlier version number, but not vice versa. When code indicates a lower version number but a higher version number is available, the version-aware compilation facility emits a warning. When code indicates a higher version number but only a lower version number is available, the version-aware compilation facility fails the compilation. Thus, the version-aware compilation facility enables the compiler to support versioning of data types.

FIG. 17 is a block diagram indicating inheritance of types. A version 1 of a type “D” 1706 inherits from a type “C” 1704. This type “C” inherits from a type “A” 1702. A version 2 of type “D” 1708 inherits from type “A” 1702. Version 1 of type “D” may be provided by one file, such as a dynamic link library (DLL), whereas version 2 of type “D” may be provided by another file. When this occurs, compilation of source code that employs type D may succeed, but whether or not an application functions as expected depends on whether the two type Ds are compatible.

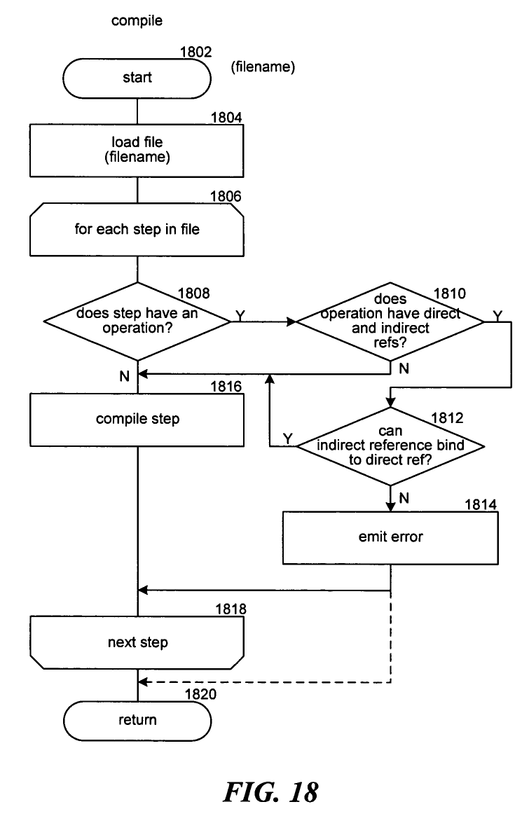

FIG. 18 is a flow diagram illustrating a compile routine invoked by a version-aware compilation facility in various embodiments. The version-aware compilation facility invokes the compile routine to check for versions of types during compilation and to identify potential errors. The routine begins at block 1802 where it receives an indication of a source code file as a parameter. In various embodiments, the routine receives an indication of a project as a parameter.

At block 1804, the routine loads the indicated file. When a project is indicated at block 1802, the routine may load and process each source code file of the project.

Between the loop of blocks 1806 and 1818, the routine processes the steps in the indicated source code file. At block 1806, the routine selects a step in the source code file.

At block 1808, the routine determines whether the step has an operation. If the step has an operation, the routine continues at block 1810. Otherwise, the routine continues at block 1816.

At block 1810, the routine determines whether the operation has direct and indirect references. If the operation has direct and indirect references, the routine continues at block 1812. Otherwise, the routine continues at block 1816.

At block 1812, the routine determines whether the indicated reference of the operation can bind to the direct reference. If the indicated reference can bind to the direct reference, the routine continues at block 1816 because no error is indicated. However, if the indirect reference cannot bind to the direct reference, the routine emits a compilation error at block 1814. The routine can then continue at block 1818 to continue compilation. In some embodiments, the routine continues at block 1820, such as when the error is considered to be “fatal” and compilation must terminate.

At block 1816, the routine compiles the selected step as it would conventionally.

At block 1818, the routine selects another step. When all steps of the indicated source code file have been processed, the routine continues at block 1820 where it returns. Otherwise, the routine continues at block 1808.

Those skilled in the art will appreciate that the blocks illustrated in the flow diagrams and in each of their corresponding descriptions may be altered in a variety of ways. As an example, the order of the blocks may be rearranged, substeps may be performed in parallel, shown blocks may be omitted, or other blocks may be included, etc.

It will be appreciated by those skilled in the art that the above-described facility may be straightforwardly adapted or extended in various ways. For example, while the various facilities are described as associated with programming language compilers, they can also be associated with programming language interpreters. As another example, while particular annotation keywords are provided as examples, other annotation keywords can be employed. As another example, while various aspects are described in relation to the Java language, the concepts may equally apply to other computer programming languages, such as a J# language. As another example, while multiple compile methods are illustrated, some or all of the compile methods may be combined. While the foregoing description makes reference to particular embodiments, the scope of the invention is defined solely by the claims that follow and the elements recited therein.

We claim:

1. A method performed by a computing system for automatically mapping property accessor methods conforming to a first style to property accessor methods conforming to a second style, comprising:
receiving source code identifying a property accessor method definition, the property accessor method definition defining a property accessor method conforming to the first style, the first style being incompatible with an operating environment for which the source code is being compiled, the identifying including locating an annotation tag corresponding to the property accessor method definition;
compiling the source code, the compiling including locating a step of the source code that invokes a property accessor method wherein the invoked property accessor method conforms to the first style of property accessor methods; and
mapping the property accessor method in the located step to a property accessor method conforming to the second style of property accessor methods by emitting an instruction to invoke the property accessor method conforming to the second style instead of emitting an instruction to invoke the property accessor method conforming to the first style, the second style being compatible with the operating environment for which the source code is being compiled.

2. The method of claim 1 wherein the annotation tag appears in the source code near the accessor method definition.

3. The method of claim 1 wherein the annotation tag is “@bean property.”

4. The method of claim 1 wherein the annotation tag appears within a comment block of the source code.

5. The method of claim 1 wherein the first style is a Java Beans style and the second style is a .NET style.

6. The method of claim 1 wherein the compiling is performed by a compiler of a J# language.

7. The method of claim 1 wherein the compiling is performed by a programming language interpreter.

8. The method of claim 1 wherein multiple property accessor method definitions appear in the source code that are be mapped to multiple styles of accessor methods by indicating an annotation tag for each of the multiple styles of accessor methods.

9. A method performed by a computer system for enabling parameters to be provided by reference when invoking a function that is designed in a computer programming language that does not natively support providing parameters by reference, comprising:
receiving source code having a function declaration and a function call, the function declaration having an annotation indicating that an annotated parameter is to be received by the function that is being declared as a by-reference parameter;
compiling the received source code wherein the compiling includes indicating in metadata associated with a compiled form of the source code that the annotated parameter is to be received by reference; and
for each instance of the function call, determining from the metadata that the function is to be provided with the annotated parameter by reference and emitting instructions indicating that the parameter's address should be provided.

10. The method of claim 9 wherein the computer programming language is a Java programming language and the compiled form of the source code executes on a .NET software platform.

11. The method of claim 9 wherein the computer programming language is J#.

12. The method of claim 9 wherein the annotation is “@ref.”

13. The method of claim 9 wherein the function receives multiple parameters and some of the parameters are provided by reference.

14. The method of claim 9 wherein the compiling is performed by a programming language interpreter.

15. The method of claim 9 wherein the instructions are emitted in an intermediate language.

16. The method of claim 15 wherein the intermediate language executes on a common language runtime.

17. The method of claim 15 wherein the intermediate language is Java byte code that is executed by a Java virtual machine.

18. A computer-readable medium have computer-executable instructions for performing a method of compiling partially complete classes, comprising:
receiving multiple files containing source code, at least two of the multiple source code files containing a partial definition of a class wherein at least one of the partially defined classes is indicated to be partially defined;
compiling all source code files but postponing the compilation of the partially complete source code files until all the other source code files have been compiled; and
creating a union of the source code contained in the files that have not yet been compiled and compiling the union, the union completing the partially defined class.

19. The computer-readable medium of claim 18 wherein the class is defined in a programming language is similar to the Java programming language.

20. The computer-readable medium of claim 18 wherein a class is indicated to be partially defined by an annotation that appears near a definition of the class in one of the source code files.
